(19) United States
(12) Patent Application Publication
(10) Pub. No.: US 2026/0134004 A1
(43) Pub. Date: May 14, 2026

(54) Automatic Prompt Trainer for Applications Using Large Language Models (LLMs)

(71) Applicant: Oracle International Corporation, Redwood Shores, CA (US)

(72) Inventor: Praphul Singh, Pleasanton, CA (US)

(21) Appl. No.: 18/946,629

(22) Filed: Nov. 13, 2024

(51) Int. Cl. G06F 16/332; G06F 16/33

(52) U.S. Cl. CPC G06F 16/3329; G06F 16/3344

(57) ABSTRACT

In one embodiment, a non-transitory computer-readable media stores instructions executable by processors for accessing a user input including a task description and a set of training data configured for prompt tuning, generating a baseline prompt based on the task description by an optimizer large language model (LLM), generating an output responsive to the user input based on the baseline prompt by a target LLM, generating modifications to the baseline prompt based on the set of training data and the output by the optimizer LLM, and generating a final prompt based on the modifications by the optimizer LLM.

### TECHNICAL FIELD

This disclosure generally relates to artificial intelligence and natural language processing, and in particular relates to large language models.

### BACKGROUND

A large language model (LLM) is a type of machine learning model notable for its ability to achieve general-purpose language generation and other natural language processing tasks such as classification. Based on language models, LLMs acquire these abilities by learning statistical relationships from text documents during a computationally intensive self-supervised and semi-supervised training process. LLMs can be used for text generation, a form of generative artificial intelligence (AI), by taking an input text and repeatedly predicting the next token or word.

Large language models (LLMs) have demonstrated remarkable capabilities in various natural language processing tasks. However, the effectiveness of LLMs may rely on the quality of the prompts provided as input. Crafting effective prompts often requires expertise in natural language processing, a deep understanding of the LLM's capabilities and limitations, and iterative experimentation, which may pose a significant challenge for data scientists and product managers who may not possess the necessary expertise or time to manually optimize prompts.

### BRIEF DESCRIPTION OF THE DRAWINGS

FIG. 1 illustrates an architecture of an auto prompt trainer system, according to at least one embodiment.

FIG. 2 illustrates a process for automatically optimizing a prompt for an LLM, according to at least one embodiment.

FIG. 3 illustrates a method for optimizing a prompt for an LLM, according to at least one embodiment.

FIG. 4 illustrates a machine learning engine, according to at least one embodiment.

FIG. 5 illustrates the operation of a machine learning engine, according to at least one embodiment.

FIG. 6 illustrates an example computer system, in which various embodiments may be implemented.

### DESCRIPTION OF EXAMPLE EMBODIMENTS

### Overview

According to an embodiment, one or more computer-readable non-transitory storage media stores instructions that, when executed by one or more processors, cause performance of the following operations. The operations include accessing a user input that includes a task description and a set of training data configured for prompt tuning. The operations also include generating a baseline prompt based on the task description by an optimizer large language model (LLM). The operations additionally include generating an output responsive to the user input based on the baseline prompt by a target LLM. The operations also include generating one or more modifications to the baseline prompt based on the set of training data and the output by the optimizer LLM. The operations further include generating a final prompt based on the one or more modifications by the optimizer LLM.

In certain embodiments, the operations include accessing a user query associated with a task associated with the task description. The operations further include generating a response to the user query based on the final prompt by the target LLM.

In certain embodiments, the operations include accessing the target LLM via an application programming interface (API).

In certain embodiments, the one or more modifications include one or more of modifying prompt structure, adjusting wording, providing additional context, or incorporating relevant examples.

In certain embodiments, the set of training data include one or more input-output pairs. Each input-output pair includes an example input to an LLM and an example output by the LLM. In some embodiments, the example output exemplifies one or more of a desired output style, a desired output format, or an output requirement. In some embodiments, generating the output responsive to the user input by the target LLM and based on the baseline prompt and generating the modifications to the baseline prompt by the optimizer LLM and based on the set of training data and the output are iterated for a number of iterations corresponding to a number associated with the input-output pairs. During each iteration, generating the modifications to the baseline prompt by the optimizer LLM is based on one distinct input-output pair of the input-output pairs. In some embodiments, the set of training data include no more than five input-output pairs.

In certain embodiments, the operations include providing to the optimizer LLM an instruction to incorporate chain-of-thought reasoning when generating prompts. Accordingly, the baseline prompt and the modifications to the baseline prompt are based on chain-of-thought reasoning.

In certain embodiments, the operations include accessing a plurality of inputs to the target LLM and plurality of outputs generated by the target LLM responsive to the respective inputs. The operations further include identifying one or more edge cases where the target LLM generated incorrect or unexpected outputs based on an analysis of the accessed inputs and outputs by the optimizer LLM. The operations also include generating one or more modifications to the baseline prompt based on the edge cases by the optimizer LLM. In some embodiments, the analysis of the accessed inputs and outputs includes one or more of anomaly detection, outlier detection, or clustering analysis.

In certain embodiments, the optimizer LLM and the target LLM are based on different models.

In certain embodiments, the optimizer LLM and the target LLM are based on a same model.

According to another embodiment, a system includes one or more processors and a non-transitory memory coupled to the processors including instructions, when executed by the processors, cause the system to execute the following operations. The operations include accessing a user input including a task description and a set of training data configured for prompt tuning. The operations also include generating a baseline prompt based on the task description by an optimizer large language model (LLM). The operations additionally include generating an output responsive to the user input based on the baseline prompt by a target LLM. The operations also include generating one or more modifications to the baseline prompt based on the set of training data and the output by the optimizer LLM. The operations further include generating a final prompt based on the one or more modifications by the optimizer LLM.

According to yet another embodiment, a method includes accessing a user input including a task description and a set of training data configured for prompt tuning. The method also includes generating a baseline prompt based on the task description by an optimizer large language model (LLM). The method additionally includes generating an output responsive to the user input based on the baseline prompt by a target LLM. The method also includes generating one or more modifications to the baseline prompt based on the set of training data and the output by the optimizer LLM. The method further includes generating a final prompt based on the one or more modifications by the optimizer LLM.

Technical advantages of certain embodiments of this disclosure may include one or more of the following. The disclosed system and method can provide an automated prompt training system that facilitates efficient creation, refinement, and testing of LLM prompts using a small amount of training data. The disclosed system and method can adapt to various open-source LLMs, thereby streamlining the development process and enhancing the performance of LLM-based applications. The disclosed system and method can increase efficiency as they automate the prompt engineering process, saving time and effort for data scientists and product managers. In certain embodiments, the disclosed system and method can improve performance of LLMs as they generate higher quality prompts, resulting in more accurate, relevant, and consistent outputs from LLMs. In some embodiments, the disclosed system and method can reduce bias as human bias is mitigated in prompt creation and refinement. The disclosed system and method can improve accessibility as the optimized prompts can make LLM technology more accessible to users with limited expertise in natural language processing. The utilization of training data may allow the disclosed system and method to adapt to specific use cases and output requirements, enhancing their versatility and effectiveness.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

LLMs are a type of machine learning model trained on a vast dataset, often including billions of words taken from books, the web, and other sources, to generate human-like, contextually relevant responses to queries. Because LLMs are designed to understand questions, i.e., prompts in LLM terminology, and generate natural language responses, they can perform tasks such as answering customer questions, summarizing information in a report, generating first drafts of emails, even writing poetry and computer code. LLMs typically have a deep understanding of the grammar and semantics of the language in which they are trained, and they can be refined. For an LLM to generate an effective, accurate, and useful response, a query or input may be given to the LLM. Such query or input is referred as a prompt for an LLM. The quality of the prompt directly affects the quality of the response from the LLM. Common types of prompts include questions, statements, responses, and detailed instructions.

In particular embodiments, an auto prompt trainer system generates an optimized prompt for an LLM. The auto prompt trainer system first uses an optimizer LLM to generate a baseline prompt based on a task description. The auto prompt trainer system then uses an iterative refinement process below to optimize the baseline prompt. In the iterative refinement process, the generated prompt is fed into a target LLM, which outputs a response accordingly. The optimizer LLM then analyzes the response to determine modifications to the baseline prompt. In addition, the optimizer LLM utilizes a small set of training data including input-output pairs that exemplify the desired output style and requirements to fine-tune the baseline prompt. Based on the modifications and fine-tuning, the optimizer LLM generates an optimized prompt. The optimized prompt is again inputted into the target LLM for another iteration. The iterative refinement process is continued until convergence on a final prompt that consistently produces the desired outcomes. Although this disclosure describes optimizing particular prompts by particular system in a particular manner, this disclosure contemplates optimizing any suitable prompt by any suitable system in any suitable manner.

Conventional prompt engineering may involve a time-consuming and labor-intensive process of trial and error. Data scientists and product managers often resort to manually creating and refining prompts, relying on intuition and limited feedback from the LLM's output. This approach can be inefficient, prone to human bias, and can lead to suboptimal results. This disclosure describes an automated solution that can assist data scientists and product managers in the following capacities. One capacity is prompt generation, e.g., automatically generating initial prompts based on a description of the desired task or outcome. Another capacity is prompt refinement, e.g., analyzing LLM outputs and suggesting modifications to the prompt to improve accuracy, relevance, or desired stylistic elements. Another capacity is edge case identification, e.g., identifying potential edge cases where the LLM may produce unexpected or incorrect outputs and suggesting prompt modifications to address these cases. Another capacity is training data utilization, e.g., leveraging a small set of training data to fine-tune prompts and adjust them to the desired output style and requirements. Another capacity is target LLM adaptability, e.g., accommodating a variety of open-source LLMs, thereby allowing users to leverage the system with their preferred language models.

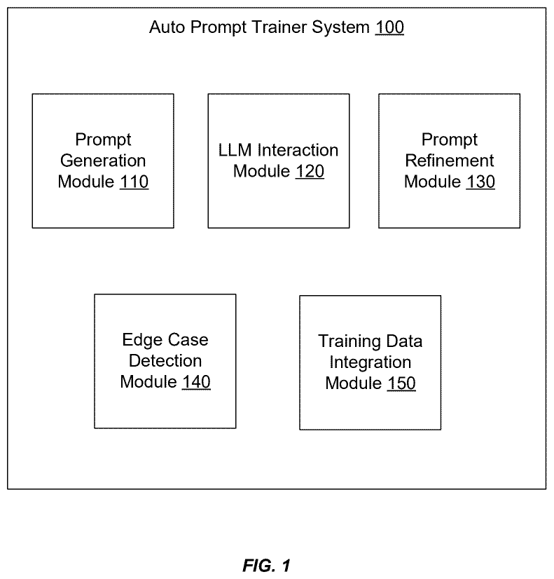

FIG. 1 illustrates an architecture of an auto prompt trainer system 100, according to at least one embodiment. To addresses the aforementioned challenges, the embodiments herein disclose an auto prompt trainer system 100. The auto prompt trainer system 100 may use a modular architecture designed for flexibility and adaptability, accommodating various open-source target LLMs and requiring minimal training data (as few as 5 input-output pairs). The auto prompt trainer system 100 may include a prompt generation module 110, an LLM interaction module 120, a prompt refinement module 130, an edge case detection module 140, and a training data integration module 150.

The prompt generation module 110 may utilize an optimizer LLM such as GPT-4 to generate initial prompts based on user input, such as task descriptions, desired output formats, or example outputs.

The LLM interaction module 120 may interact with the target LLM, providing prompts as input and receiving outputs. The LLM interaction module 120 may analyze the LLM's responses to identify potential areas for improvement. The LLM interaction module 120 may be adaptable to various open-source LLMs through the use of standardized interfaces or API calls. The adaptability of the LLM interaction module 120 can ensure broad compatibility without requiring extensive modifications or specialized knowledge for different LLMs.

The prompt refinement module 130 may suggest modifications to the prompt, such as adjusting the wording, providing additional context, or incorporating relevant examples, based on the analysis of LLM outputs and user feedback.

The edge case detection module 140 may employ techniques such as anomaly detection or clustering to identify potential edge cases where the LLM may struggle to produce accurate or desired outputs.

The training data integration module 150 may access a small set of training data, consisting of input-output pairs, and utilize it to fine-tune the prompt and adjust it to the desired output style and requirements. This fine-tuning process may allow system 100 to learn from specific examples and improve its ability to generate prompts that produce the desired outcomes, even with limited data.

The modular architecture of the auto prompt trainer system 100 can allow individual components to be improved or replaced independently, facilitating continuous development and adaptation to evolving LLM capabilities and user needs. The compatibility with various open-source target LLMs and efficient utilization of small training datasets underscore its versatility and effectiveness across diverse natural language processing tasks.

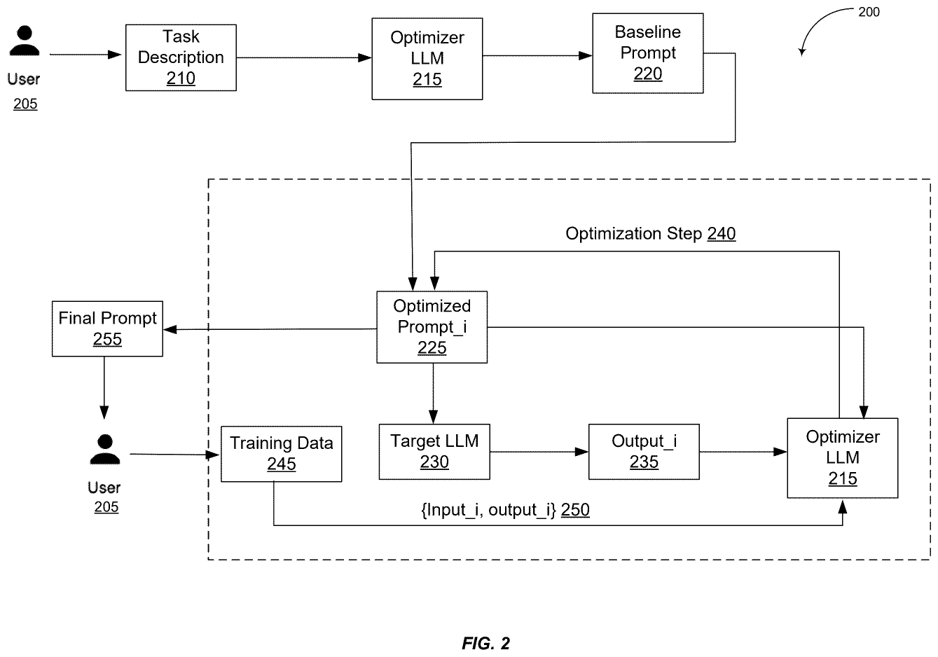

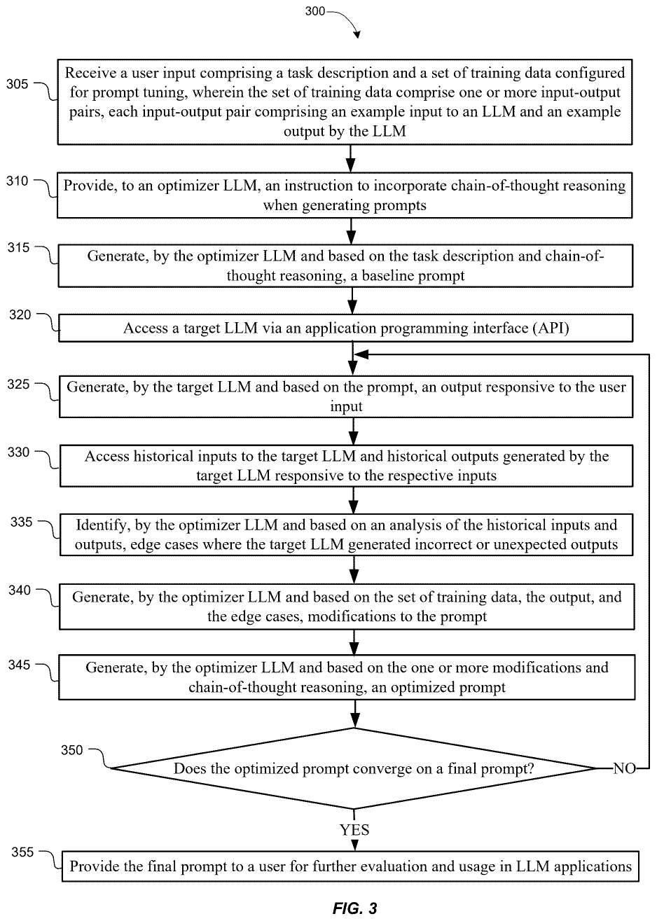

The details of each module shown in FIG. 1 will be described below with reference to FIG. 2 and FIG. 3.

FIG. 2 illustrates a process 200 for automatically optimizing a prompt for an LLM, according to at least one embodiment. The process 200 initiates with a user 205 providing a user input. As used herein, a user can refer to any individual, entity, or system that interacts with the auto prompt trainer system 100. As an example and not by way of limitation, the user may be a human operating a computer or software, an organization, entity, or company using a tool or system, any automated system or application that interacts with the auto prompt trainer system 100, any combination thereof, or any suitable type of users. In particular embodiments, the user input may include a task description 210 and a small set of training data (e.g., 5 input-output pairs) that exemplify the desired output style and requirements. The task description 210 may outline the intended goal or objective for a target LLM, while the training data may serve as a guide for prompt tuning.

Leveraging the task description 210, the prompt generation module 110 can then generate a baseline prompt. The prompt generation module 110 may employ natural language processing techniques and incorporate machine learning models trained on diverse prompt structures and best practices. In particular embodiments, the prompt generation module 110 may use an optimizer LLM 215 to generate the baseline prompt 220. The optimizer LLM 215 can be any suitable LLM such as ChatGPT 4, Gemini 1.5 Pro, Claude 3.5. In particular embodiments, the optimizer LLM 215 may generate prompts that incorporate chain-of-thought reasoning. To do that, the user input may also include an instruction for the optimizer LLM 215 to generate a chain-of-thought (COT) styled prompt. Chain-of-thought reasoning may significantly enhance the optimizer LLM's 215 abilities to follow complex instructions, maintain coherence, and produce outputs that are highly aligned with the desired style and task relevance.

The generated baseline prompt 220 is then passed to the LLM interaction module 120 to iterate in an iterative optimization loop as indicated by the dashed-line box in FIG. 2. In the initialization step (i.e., i=0), the optimized prompt_i 225 is the baseline prompt 220, which is input into the target LLM 230. The process 200 then starts the first iteration, for which the target LLM 230 processes the prompt 225 and generates output_i (i.e., i=1) 235. Output_i 235 is subsequently analyzed by the optimizer LLM 215 to identify potential weaknesses, biases, or areas for enhancement. This analysis can form the basis for the iterative optimization loop aimed at prompt optimization via the optimization step 240, after which an optimized prompt_i 225 (i=1 as indicating the first interaction being completed) is generated. The optimized prompt_i 225 is then input into the target LLM 230 for the next iteration (i.e., second iteration for which i=2).

Within the iterative optimization loop, the following modules may collaborate to refine the prompt.

Based on the analysis of the LLM output_i 235, the prompt refinement module 130 may suggest modifications to the prompt structure, wording, context, or examples to improve clarity, specificity, or achieve the desired style in the output_i 235.

The edge case detection module 140 may focus on identifying instances where the target LLM's 230 output deviates from expectations or exhibits unexpected behavior. Techniques like outlier detection or clustering analysis on the generated outputs can be employed for this purpose.

Despite the limited training data, the training data integration module 150 can effectively leverage the provided training data (e.g., example input-output pairs) to fine-tune the prompt. As indicated in FIG. 2, the user 205 may provide the training data 245 as associated with the user input. By analyzing the training data, the optimizer LLM 215 can optimize the prompt to better align with the desired output style and format, ensuring that the target LLM's 230 responses meet the specific requirements of the task. In particular embodiments, in each iteration (e.g., i-th iteration), the i-th input-output pair ({input_i, output_i} 250 is provided to the optimizer LLM 215 for analysis. The auto prompt trainer system 100 can effectively utilize a minimal amount of training data (e.g., as few as 5 diverse input-output pairs) to fine-tune prompts and achieve optimal performance. This data efficiency can reduce the burden on users to collect large training sets and accelerate the prompt optimization process.

The iterative optimization loop continues until the optimizer LLM 215 converges on an optimized prompt_i 225 that consistently produces the desired outcomes and addresses potential edge cases. This optimized prompt 225 is then presented to the user 205 as a final prompt 255 for further evaluation and application within their LLM applications.

The entire prompt optimization process 200, from baseline prompt generation to refinement and edge case handling, can be automated, thereby eliminating the need for manual intervention and significantly speeding up the development cycle. The automation can allow data scientists and product managers to focus on higher-level tasks and applications while the auto prompt trainer system 100 efficiently optimizes the LLM prompts.

The disclosure below goes through an example of generating a prompt for a target LLM to extract identifiable information from a medical text. In the example, the target LLM is Llama-3, the optimizer LLM is GPT-4, and the task is to extract all identifiable entities from a given medical text. The training data includes 5 pairs of medical texts and their extracted entities.

As an example and not by way of limitation, the input of the first pair is: “But how's John doing? He's good. He's coughing still since RSV. That's been like five, six weeks ago. But he's now, so he went to a lung specialist on Friday and he has a different nebulizer that has a steroid in it and they want him to use it every night. They said everything's kind of pointing to asthma. But he's got like, it looks like blood vessels popped like the little red dots like when he had that when he had RSV but that was only on his chest he never had it on his face and now it's like on his neck and his face and I thought these were pimples but they're not they're part of whatever this is. Obviously to make sure I know it's obviously from the RSV diagnosis that was December 13th ended up then right after Christmas and Children's was there for three four nights. He was there for like six days, but half of that was it was influenza and ear infection and then it went into just being constipated really bad. I knew that. Okay, and then we had a follow-up on the fifth. Let's see, I just see this. Must've seen Dr. Smith. He did a two-year check and hospital follow-up. Does that sound right? Yep. Pulmonologist started on Friday with the naps and is that budesonide? Yes. So that he wants that done every night by supper time. I did it this morning also because he was coughing really bad. And then I'll do it again at supper time, but I've never seen this on his face and around his eyes like this. So I was just curious if he's okay still And it's on his neck. All of this stuff you're saying? This is just from being in the car at birth, but all of it, yes. Yeah, you're doing really good, bud. I know we're working you hard here. Yep. We're working you hard. All around you. Appetite's been okay. Yeah, he eats quite good. Peeing and pooping okay. Um, peeing, for sure, um, he's . . . . As of today, how's the cough? He's, I feel like he's coughing more than . . . . Sounds like he's got a cold or something. Yeah, he'll sneeze and, no, no fever. Sneeze, everything comes out. What was the last fever, a month ago? Influenza. Okay, and, um, pees and poops are okay. Nosebleeds? No. Peeing or pooping any blood. Mm-hmm. Did we poop today? Not yet. Are we really pooping daily now? Daily. Yeah. Diapers on? Yep. Working on potty training. So slowly. Okay. It's more of us being kind of lazy about. It. If you hadn't had the rash, what would you have said about him today? Um, I said he's okay. Coughing, yeah, more like in the last couple days I feel like this coughing is a little extra but that's why I called the lung specialist and then we talked or he got an appointment with him on Friday. So we went to that and they said he sounds good but he's he didn't have this then. He just had this and it looked like pimples to me and then now it's like a rash looking thing and I don't, that makes me nervous. Because like I said the last time he had this was when he had RSV and it was, he was coughing so bad it would pop the blood vessels. But now it's been so long of him being sick, I don't know, like, does he have something else, or? Sure, I can recognize your concern as a physician. I think any physician, if I walked in, 12 physicians, I think we would offer the same kind of discernment, discussion, discovery. It's described as a petechial rash, which does mean there's a little capillary or blood vessel leakage, that's the root of it, I think it is capillary or blood vessel, obviously very similar to like that cough, someone coughs, they get a little bleeding in their eye or they get something that's such a profound cough for us, I don't think that's the case like now, I'm not trying to say like oh he seems like he's coughing so hard again but this is the case. I also as a doctor see this type of a petechial, petechial means capillary blood vessel leakage, this petechial type rash from a variety of other things, could be from a virus, could be from a high fever, could be from allergic reaction, could be, it's not from the Budesonide. I would say as a doctor I'm struggling a little bit to say why. It's very real, it's there, etc. I agree before it was cough related, I'm not saying it's cough related now. A lot of times it comes from a, and I know this is all medical terms, but it comes from a more of a body wide system inflammation response. Maybe like if you came in, you had a viral infection that went in your bloodstream. Now, if the case was him, he′d be way sick. You know what I mean? Just would be a sicker kid if you had a body-wide inflammation, infection. So I'm struggling other than acknowledge that it's there. I guess what I would say is the rest of the facts, all of it are reassuring to me. I don't think I would do anything other than watch it. Now, many times a particular rash will take us a good week or 10 days to go away because you're kind of resolving some of that little bit of a blood leakage. There's just nothing else I would do. I think I agree about the pulmonologist course and obviously with that flu, bronchiolitis, bronchitis, that asthma activation, the question would be, do you have some asthma components in him? And now the infection is uncovered a little bit. It'd be like the same as if you were a pre-diabetic, no problems, and then suddenly you got pregnant. Now I'm a gestational pregnancy diabetes, like I uncovered it. So I'm questioning if the illness has compounded that asthma potential that he has. But again, that's gonna be management over the next weeks and months, you know, where it's like, how are we doing? Do you understand that? Yeah. So the Budesta, if you call back to the pulmonologist each week, you might be like, yeah, I'm honestly looking for 10% improvement. I'm looking for slow gains over time. You have follow up with the pulmonologist? Like a follow phone call a month. He said not till like six months. but is there, do you want me to call him? No, not now. I just think that there's gotta be follow-up related to, if he started on Friday to be destined, it's probably after a month, says, how's that working? You know, is that the right thing? And I would say, unfortunately, for this little guy, we can't necessarily do the inhalers, you know, whereas you might do inhalers. So for now, for a month, we're doing the nebs. I just, and that could be me, it could be Dr. Smith. I just think someone, you know, touch base, like, hey, we're doing okay as far as the breathing. Yeah, yeah, I agree. They just said we're going to try the, I think because I call for anything that comes close to something with him because my dad has lung disease for a long time and so then, now I'm just nervous. I don't want him to have that obviously, but it just makes me nervous. So what I would say, Mom, that I can match your worry, but if it's my kid, I would treat each kid like my kid. I think the cough, respiratory status is okay, but ultimately that petechia rash, we just to watch. Yeah. So nothing that represents something I would tell you to do a blood cell count, look for further infection, anything, I would just watch for. Now. Okay. Questions at all about John? Anything else I haven't asked you about? No. Dad, any questions? Um. No. Okay. Probably try to stay Brothers Things non-stop. Yep. Um, how are you doing, Diana? I'm good.”

Continuing with the previous example, the output of the first pair is: {‘PERSON’: [‘He’, ‘Dr. Smith’, ‘John’, ‘Diana’], ‘ADDRESS’: [ ], ‘AGE’: [‘two-year’], ‘GENDER’: [“you're”, ‘us’, ‘me’, ‘him’, ‘we’, ‘He’, “he's”, ‘my’, ‘his’, “we're”, ‘he’, ‘I’, ‘your’, ‘you’, “they're”, ‘they’], ‘APPROXIMATE_LOCATION’: [ ], ‘MARITAL_STATUS’: [ ], ‘PARENTHOOD’: [‘dad’, ‘John’], ‘OCCUPATION’: [ ], ‘RACE’: [ ], ‘ETHNICITY’: [ ], ‘LANGUAGE’: [ ], ‘DATE_TIME’: [‘the fifth’, ‘December 13^{th}’, ‘daily’, ‘a week or 10 days’, ‘a month ago’, ‘this morning’, ‘at supper time’, ‘six days’, ‘today’, ‘a month’, ‘six months’, ‘Friday’], ‘DATE’: [‘the fifth’, ‘Christmas’, ‘a month ago’, ‘today’, ‘December 13^{th}’, ‘Friday’], ‘TIME’: [‘supper time’, ‘this morning’], ‘FREQUENCY’: [‘daily’, ‘every night’, ‘Daily’], ‘INTERVAL’: [‘six days’], ‘DURATION’: [‘a week’, ‘three four nights’, ‘10 days’, ‘two-yea”, ‘a good week’, ‘six days’, ‘a month’, ‘five, six weeks’, ‘six months’], ‘SSN_OR_TAXPAYER’: [ ], ‘EMAIL’: [ ], ‘PASSPORT_NUMBER_US’: [ ], ‘TELEPHONE_NUMBER’: [ ], ‘DRIVER_ID_US’: [ ], ‘BANK_ACCOUNT_NUMBER’: [ ], ‘BANK_SWIFT’: [ ], ‘BANK_ROUTING’: [ ], ‘CREDIT_DEBIT_NUMBER’: [ ], ‘MEDICAL_RECORD_NUMBER’: [ ], ‘HEALTH_PLAN_ID’: [ ], ‘CERTIFICATE_NUMBER’: [ ], ‘FIN’: [ ], ‘VEHICLE_LICENSE_PLATE_US’: [ ], ‘VEHICLE_IDENTIFIER_US’: [ ], ‘GUID’: [ ], ‘URL’: [ ], ‘IP_ADDRESS’: [ ], ‘MAC_ADDRESS’: [ ], ‘OTHER’: [‘Ear infection’, ‘two-year check’, ‘asthma activation’, ‘constipated’, ‘bronchitis’, ‘influenza’, ‘Dr. Smith’, ‘gestational pregnancy diabetes’, ‘budesonide’, ‘petechial rash’, ‘flu’, ‘hospital follow-up’, ‘bronchiolitis’, ‘December 13^{th}’, ‘viral infection’, ‘capillary or blood vessel leakage’, ‘lung disease’, ‘RSV diagnosis’, ‘Budesta’], ‘ORGANIZATION’: [“Children's”], ‘PHARDIANA’: [ ], ‘DIAGNOSTIC LABS’: [ ]}.

The example prompt optimization process is then as follows. The optimizer LLM 215 firstly generates a baseline prompt 220 given the task description 210 and the training data 245 as below.

An example baseline prompt 220 may be as follows. The example baseline prompt 220 may include: (base) prapsing-mac:llm_trainer prapsing$ python auto_prompt.py “The task is to extract all identifiable entities from a given medical text” tune_prompt_data.csv Initial Prompt #Here is the filled prompt template: . . . .

The example baseline prompt 220 may also include a role definition. For example, the role definition may be: As an AI, your role is to extract all identifiable entities form a given medical text. This includes but is not limited to medical conditions, treatments, medications, procedures, and anatomical terms.

The example baseline prompt 220 may additionally include an instruction for chain of thought, which may include: 1. read the provided medical text. 2. Identify and extract all medical entities present in the text. 3. Ensure that the extracted entities are relevant to the medical field.

The example baseline prompt 220 may also include additional guidelines. For example, these guidelines can include: —Be thorough in your extraction. The text may contain multiple instances of the same entity or different entities. —Be aware of the context. Some words may have different meaning in different contexts. —Ensure accuracy. Incorrectly identified entities can lead to misinformation.

The example baseline prompt 220 may additionally include the output format. For example, the output should be a list of extracted entities, each entity represented as a string.

The example baseline prompt 220 may further include example output. For example, the example output may be: [‘diabetes’, ‘insulin’, ‘blood sugar’, ‘metformin’, ‘hypoglycemia’].

The target LLM 230 then generates an output 235 based on the prompt, which is evaluated by the optimizer LLM 215 as below. The output 235 may include: Running iteration #1 . . . .

The output 235 may also include feedback and edge cases. For example, such feedback and edge cases may include: 1. The system might struggle with understanding and extracting entities from complex medical jargon or terms. 2. The system might not correctly identify entities when they are referred to indirectly or through pronouns. 3. The system might not correctly identify entities when they are embedded in a long, complex sentence structure. 4. The system might struggle with identifying entities when they are not explicitly mentioned but implied in the context.

The output 235 may also include enhancement feedback. For example, such enhancement feedback may include: 1. The system should improve its understanding of medical terms and jargon. This can be achieved by training the system with more medical literature or data. 2. The system should improve its ability to identify entities referred to indirectly or through pronouns. This can be achieved by improving the system's context understanding capabilities. 3. The system should improve its ability to extract entities from complex sentence structures. This can be achieved by improving the system's natural language processing capabilities. 4. The system should improve its ability to identify implied entities. This can be achieved by improving the system's inference capabilities.

The optimizer LLM 215 then modifies the prompt based on the feedback as below. An example modified prompt may include: Modified Prompt # . . . .

The example modified prompt may also include role definition, which may be: As an AI, your role is to extract all identifiable entities from a given medical text. This includes but is not limited to medical conditions, treatments, medications, procedures, and anatomical terms.

The example modified prompt may also include the instruction for chain of thought, which may include: 1. Read the provided medical text. 2. Identify and extract all medical entities present in the text. 3. Ensure that the extracted entities are relevant to the medical field. 4. Pay attention to the context and indirect references to medical entities. 5. Understand and extract entities from complex medical jargon or terms. 6. Identify entities from complex sentence structures. 7. Infer and identify entities that are not explicitly mentioned but implied in the context.

The example modified prompt may also include additional guidelines. For example, such guidelines may include: —Be thorough in your extraction. The text may contain multiple instances of the same entity or different entities. —Be aware of the context. Some words may have different meanings in different contexts. —Ensure accuracy. Incorrectly identified entities can lead to misinformation. —Improve your understanding of medical terms and jargon. —Improve your ability to identify entities referred to indirectly or through pronouns. —Improve your ability to extract entities from complex sentence structures. —Improve your ability to identify implied entities.

The example modified prompt may also include the output format. For example, the output should be a dictionary where the keys are the types of entities (e.g., ‘PERSON’, ‘DATE TIME’, ‘OTHER’, etc.) and the values are lists of extracted entities of that type, each entity represented as a string.

The example modified prompt may additionally include example output. For example, the example output may be:

{
‘PERSON’: [‘He’, ‘Dr. Smith’, ‘John’, ‘Diana’],
‘DATE TIME’: [‘the fifth’, ‘December 13^{th}’, ‘daily’, ‘a week or 10 days', ‘a month ago’,
‘this morning’, ‘at supper time’, ‘six days', ‘today’, ‘a month’, ‘six months', ‘Friday’],
‘OTHER’: [‘Ear infection’, ‘two-year check’, ‘asthma activation’, ‘constipated’,
‘bronchitis', ‘influenza’, ‘Dr. Smith’, ‘gestational pregnancy diabetes', ‘budesonide’,
‘petechial rash’, ‘flu’, ‘hospital follow-up’, ‘bronchiolitis', ‘December 13th’, ‘viral
infection’, ‘capillary or blood vessel leakage’, ‘lung disease’, ‘RSV diagnosis', ‘Budesta’],
‘ORGANIZATION’: [“Children's”]
}

The iteration continues until the training data 245 is exhausted, e.g., all the input-output pairs are used for fine-tuning.

The final prompt 255 is then as below. An example final prompt 255 may include: FINAL PROMPT # . . . .

The example final prompt 255 may also include role definition. For example, the role definition may be: At an AI, your role is to extract all identifiable entitles tram a given medical text. This includes but is not limited to medical conditions, treatments, medications, procedures, and anatomical terms.

The example final prompt 255 may also include an instruction for chain of thought. The instruction may include: 1. Read the provided medical text. 2. Identify and extract all medical entities present in the text. 3. Ensure that the extracted entitles are relevant to the medical field. 4. Pay attention to the context and indirect references to medical entitles. 5. Understand and extract entities from complex medical jargon or terms. 6. Identify entities from complex sentence structures. 7. Infer and identify entities that are not explicitly mentioned but implied in the context. 8. Recognize specific drug names as ‘MEDICATION’. 9. Recognize job-related phrases as ‘OCCUPATION’ related entities. 10. Recognize well-known organizations or companies. 11. Recognize common medical conditions. 12. Recognize common medical tests or measurements. 13. Link pronouns to their respective entities. 14. Identity multiple instances of the same entity. 15. Understand the implied entities in the context. 16. Identify different terms used to refer to family members such as ‘mommy’ as ‘PERSON’. 17. Identify occupations even Mien they are not directly associated with a person. 18. Identity marital status from phrases like ‘Home wife’. 19. Identity parenthood from phrases like ‘two kids’. 20. Identify gender from words like ‘guys’. 21. Identify frequency from phrases like ‘daily’, ‘every day’, ‘every now and again’. 22. Identify dates from phrases like ‘fall’, six months’, ‘past meek’, ‘week’, ‘meek end a half’, ‘A month or two ago’, ‘today’, ‘next two days’, ‘three, four weeks’, ‘this week’. 23. Identify duration from phrases like ‘a good while now’. 24. Identity diagnostic labs from phrases like ‘Cologuard’. 25. Identify other entities that do not fit into the other categories but are still relevant to the context.

The example final prompt 255 may also include additional guidelines. Such guidelines may include: —Be thorough in your extraction. The text may contain multiple instances of the same entity or different entitles. —Be aware of the context. Sam words may have different meanings in different contexts. —Ensure accuracy. Incorrectly identified entities con lead to misinformation. —Improve your understanding of medical terms and jargon. —Improve your ability to identify entities referred to indirectly or through pronouns. —Improve your ability to extract entities from complex sentence structures. —Improve your ability to identity implied entities. —Improve your ability to identity diagnostic labs. —Improve your ability to identify other entities that do not fit into the other categories but are still relevant to the context.

The example final prompt 255 may also include the output format. For example, the output format may be: the output should be a dictionary where the keys are the types at entities (e.g., ‘PERSON’, ‘DATE_TIME’, ‘OTHER’, etc.) and the values are lists of extracted entities of that type, each entity represented as a string.

The example final prompt 255 may additionally include example output. An example output may be:

{
‘PERSON’: [‘My Son’],
‘ADDRESS’: [ ],
‘AGE’: [ ]
‘GENDER’: [‘her’, ‘they’, ‘me’, ‘him’, ‘his', ‘he’, ‘she’, ‘I’, ‘your’, ‘you’, ‘them’).
‘APPROXIATE LOCATION’: [ ],
‘MARITAL STATUS’: [ ],
‘PARENTHOOD’: [‘My son is with me now’],
‘OCCUPATION’: [″I'm supposed to be working″, ″Today, I'm supposed to be working
now″, ‘miss some work’, ‘work with food’, ‘I work with food’],
‘RACE’: [ ],
‘ETHNICITY’: [ ],
‘LANGUAGE’: [ ],
‘DATE_TIME’: [‘the next month or two’, ‘three years', ‘Yesterday afternoon’, ‘Saturday
morning’, ‘this last December’, ‘31st’, ‘Saturday’, ‘two years ago’, ‘a week or two ago’,
‘a little over a year ago’, ‘29th’].
‘DATE’: [‘the next month or two’, ‘today is the 29th’, ‘three years', ‘the 31st’, ‘31 days in
January’, ‘Yesterday afternoon’, ‘Saturday morning, ‘this last December’, ‘Saturday’,
‘today’, ‘two years ace’, ‘a little over a year ago’, ‘three days ago’],
‘TIME’: [‘morning’, ‘now’],
‘FREQUENCY’: [‘one time’].
‘INTERVAL’: [ ],
‘DURATION’: [‘a week or two’, ‘three years', ‘two years ago’, ‘a year ago’, ‘three days'),
‘SSN_OR_TAXPAYER’: [ ],
‘EMAIL’: [ ],
‘PASSPORT_NUMBER_US’: [ ],
‘TELEPHONE_NUMBER’: [ ],
‘DRIVER_ID_US’: [ ],
‘BANK ACCOUNT NUMBER’: [ ].
‘BANK_SWIFT’: [ ],
‘BANK_ROUTING’: [ ],
‘CREDIT_DEBIT_NUMBER’: II,
‘MEDICAL RECORDNUMBER’: [ ],
‘HEALTH PLAN ID″: [ ],
‘CERTIFICATE_NUMBER’: [ ],
‘FIN’: [ ],
‘VEHICILE_LICENSE_PLATE_US’: [ ],
‘VEHICLE_IDENTIFIER_US’: [ ],
‘GUID’: [ ],
‘URL’: [ ],
‘IP_ADDRESS’: [ ],
‘MAC_ADDRESS’: [ ],
‘OTHER’: [‘three years', ‘the 31st’, ‘31 days in January’, ‘this Last December’, ‘Saturday
morning’, ‘the 29th’, ‘two years ago’, ‘today’, ‘120’, ‘halt an hour’),
‘ORGANIZATION’: [ ],
‘PHARDIANA’: [ ],
‘DIAGNOSTIC LABS’: [‘Cologuard’]

FIG. 3 illustrates an example method 300 for optimizing a prompt for an LLM, according to at least one embodiment. The method may begin at step 305, where the auto prompt trainer system 100 may receive a user input including a task description and a set of training data configured for prompt tuning. The set of training data may include one or more input-output pairs, each input-output pair including an example input to an LLM and an example output by the LLM. As an example and not by way of limitation, the example output exemplifies one or more of a desired output style, a desired output format, or an output requirement. At step 310, the auto prompt trainer system 100 may provide, to an optimizer LLM, an instruction to incorporate chain-of-thought reasoning when generating prompts. At step 315, the auto prompt trainer system 100 may generate, by the optimizer LLM and based on the task description and chain-of-thought reasoning, a baseline prompt. At step 320, the auto prompt trainer system 100 may access a target LLM via an application programming interface (API).

Method 300 then proceeds to an iterative optimization loop including step 325 through step 350. At step 325, the auto prompt trainer system 100 may generate, by the target LLM and based on the prompt, an output responsive to the user input. At step 330, the auto prompt trainer system 100 may access historical inputs to the target LLM and historical outputs generated by the target LLM responsive to the respective inputs. At step 335, the auto prompt trainer system 100 may identify, by the optimizer LLM and based on an analysis of the historical inputs and outputs, edge cases where the target LLM generated incorrect or unexpected outputs. At step 340, the auto prompt trainer system 100 may generate, by the optimizer LLM and based on the set of training data, the output, and the edge cases, modifications to the prompt. At step 345, the auto prompt trainer system 100 may generate, by the optimizer LLM and based on the one or more modifications and chain-of-thought reasoning, an optimized prompt. At step 350, the auto prompt trainer system 100 may determine whether the optimized prompt converges on a final prompt. As an example and not by way of limitation, determination of whether the optimized prompt converges on the final prompt is based on whether the optimized prompt consistently produces the desired outcomes and addresses potential edge cases. If the optimized prompt does not converge on a final prompt, the iterative optimization loop continues and method 300 returns to step 325.

If the optimized prompt converges on a final prompt, the iterative optimization loop ends and method 300 proceeds to step 355, where the auto prompt trainer system 100 may store the final prompt in memory and/or make the final prompt accessible (e.g., as a file, as a software program, or via an API) for further evaluation and usage in LLM applications. As an example and not by way of limitation, the target LLM may receive a user query associated with a task associated with the task description and generate a response to the user query based on the final prompt.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for optimizing a prompt for an LLM including the particular steps of the method of FIG. 3, this disclosure contemplates any suitable method for optimizing a prompt for an LLM including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

As described earlier, LLMs are a type of machine learning model. More specifically, LLMs are a type of generative model, which is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

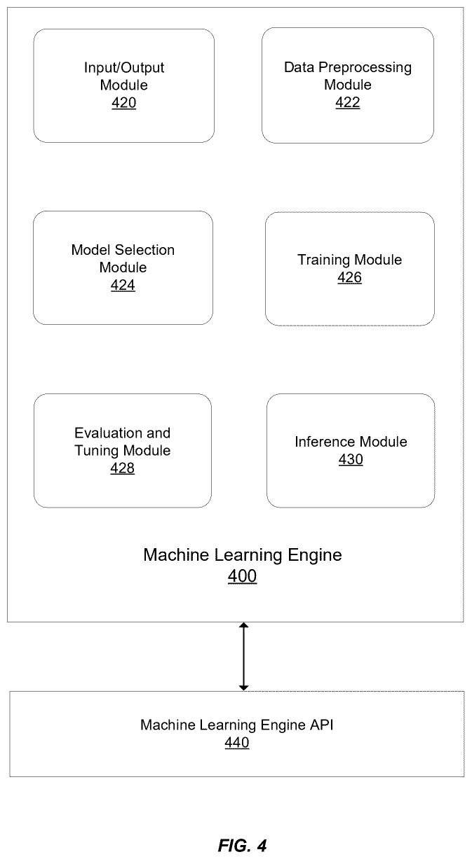

Since LLMs or generative models are machine learning based, they can be trained using a machine learning engine. FIG. 4 illustrates a machine learning engine 400, according to at least one embodiment. As illustrated in FIG. 4, machine learning engine 400 includes input/output module 420, data preprocessing module 422, model selection module 424, training module 426, evaluation and tuning module 428, and inference module 430.

In accordance with an embodiment, input/output module 420 serves as the primary interface for data entering and exiting the system, managing the flow and integrity of data. This module may accommodate a wide range of data sources and formats to facilitate integration and communication within the machine learning architecture.

In an embodiment, an input handler within input/output module 420 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 420 to be versatile in different operational contexts, whether processing historical datasets or streaming data.

In accordance with an embodiment, input/output module 420 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 420 includes an output framework designed to handle the distribution and exportation of outputs, predictions, or insights. Using the output framework, input/output module 420 formats these outputs into user-friendly and accessible formats, such as reports, visualizations, or data files compatible with other systems. Input/output module 420 also ensures secure and efficient transmission of these outputs to end-users or other systems in an embodiment and may employ encryption and secure data transfer protocols to maintain data confidentiality.

In accordance with an embodiment, data preprocessing module 422 transforms data into a format suitable for use by other modules in machine learning engine 400. For example, data preprocessing module 422 may transform raw data into a normalized or standardized format suitable for training ML models and for processing new data inputs for inference. In an embodiment, data preprocessing module 422 acts as a bridge between the raw data sources and the analytical capabilities of machine learning engine 400.

In an embodiment, data preprocessing module 422 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 422 may be configured to handle anomalies in different ways depending on context. Data preprocessing module 422 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 422 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 422 processes new data for inference, data preprocessing module 422 replicates the same preprocessing steps to ensure consistency with the training data format. This helps to avoid discrepancies between the training data format and the inference data format, thereby reducing the likelihood of inaccurate or invalid model predictions.

In an embodiment, model selection module 424 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 424 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 424 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 424 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 424 also considers computational efficiency and resource constraints. This is meant to help ensure the selected model is both accurate and practical in terms of computational and time requirements. In an embodiment, certain features of model selection module 424 are configurable such as a configured bias toward (or against) computational efficiency.

In accordance with an embodiment, training module 426 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 426 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 426 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 426 includes logic to handle different types of data and learning tasks. For instance, it includes different training routines for supervised learning (where the training data comes with labels) and unsupervised learning (without labeled data). In the case of deep learning models, training module 426 also manages the complexities of training neural networks that include initializing network weights, choosing activation functions, and setting up neural network layers.

In an embodiment, evaluation and tuning module 428 incorporates dynamic feedback mechanisms and facilitates continuous model evolution to help ensure the system's relevance and accuracy as the data landscape changes. Evaluation and tuning module 428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 428 performs continuous model tuning by using hyperparameter optimization. Evaluation and tuning module 428 performs an exploration of the hyperparameter space using algorithms, such as grid search, random search, or more sophisticated methods like Bayesian optimization. Evaluation and tuning module 428 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 428 integrates data feedback and updates the model. Evaluation and tuning module 428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 430 transforms data raw data into actionable, precise, and contextually relevant predictions. In addition to processing and applying a trained model to new data, inference module 430 may also include post-processing logic that refines the raw outputs of the model into meaningful insights.

In an embodiment, inference module 430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 430 transforms the outputs of a trained model into definitive classifications. Inference module 430 employs the underlying model as a tool to generate probabilistic outputs for each potential class. It then engages in an interpretative process to convert these probabilities into concrete class labels.

In an embodiment, when inference module 430 receives the probabilistic outputs from the model, it analyzes these probabilities to determine how they are distributed across some or every potential class. If the highest probability is not significantly greater than the others, inference module 430 may determine that there is ambiguity or interpret this as a lack of confidence displayed by the model.

In an embodiment, inference module 430 uses thresholding techniques for applications where making a definitive decision based on the highest probability might not suffice due to the critical nature of the decision. In such cases, inference module 430 assesses if the highest probability surpasses a certain confidence threshold that is predetermined based on the specific requirements of the application. If the probabilities do not meet this threshold, inference module 430 may flag the result as uncertain or defer the decision to a human expert. Inference module 430 dynamically adjusts the decision thresholds based on the sensitivity and specificity requirements of the application, subject to calibration for balancing the trade-offs between false positives and false negatives.

In accordance with an embodiment, inference module 430 contextualizes the probability distribution against the backdrop of the specific application. This involves a comparative analysis, especially in instances where multiple classes have similar probability scores, to deduce the most plausible classification. In an embodiment, inference module 430 may incorporate additional decision-making rules or contextual information to guide this analysis, ensuring that the classification aligns with the practical and contextual nuances of the application.

In regression models, where the outputs are continuous values, inference module 430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 430 incorporates domain-specific adjustments into its post-processing routine. This involves tailoring the model's output to align with specific industry knowledge or contextual information. For example, in financial forecasting, inference module 130 may adjust predictions based on current market trends, economic indicators, or recent significant events, ensuring that the outputs are both statistically accurate and practically relevant.

In an embodiment, inference module 430 includes logic to handle uncertainty and ambiguity in the model's predictions. In cases where inference module 430 outputs a measure of uncertainty, such as in Bayesian inference models, inference module 430 interprets these uncertainty measures by converting probabilistic distributions or confidence intervals into a format that can be easily understood and acted upon. This provides users with both a prediction and an insight into the confidence level of that prediction. In an embodiment, inference module 130 includes mechanisms for involving human oversight or integrating the instance into a feedback loop for subsequent analysis and model refinement.

In an embodiment, inference module 430 formats the final predictions for end-user consumption. Predictions are converted into visualizations, user-friendly reports, or interactive interfaces. In some systems, like recommendation engines, inference module 430 also integrates feedback mechanisms, where user responses to the predictions are used to continually refine and improve the model, creating a dynamic, self-improving system.

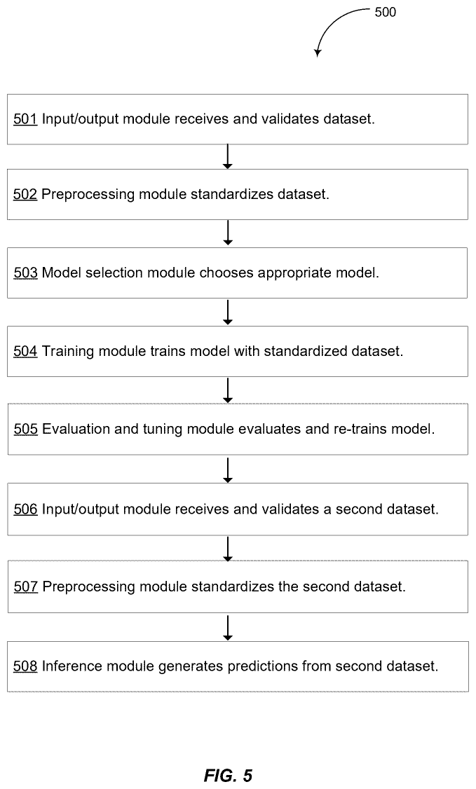

FIG. 5 illustrates the operation 500 of a machine learning engine, according to at least one embodiment. In an embodiment, input/output module 420 receives a dataset intended for training (Operation 501). This data can originate from diverse sources, like databases or real-time data streams, and in varied formats, such as CSV, JSON, or XML. Input/output module 420 assesses and validates the data, ensuring its integrity by checking for consistency, data ranges, and types.

In an embodiment, training data is passed to data preprocessing module 422. Here, the data undergoes a series of transformations to standardize and clean it, making it suitable for training ML models (Operation 502). This involves normalizing numerical data, encoding categorical variables, and handling missing values through techniques like imputation.

In an embodiment, prepared data from the data preprocessing module 422 is then fed into model selection module 424 (Operation 503). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 426 trains the selected model with the prepared dataset (Operation 504). It implements learning algorithms to adjust the model's internal parameters, optimizing them to identify patterns and relationships in the training data. Training module 426 also addresses the challenge of overfitting by implementing techniques, like regularization and early stopping, ensuring the model's generalizability.

In an embodiment, evaluation and tuning module 428 evaluates the trained model's performance using the validation dataset (Operation 505). Evaluation and tuning module 428 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 420 receives a dataset intended for inference. Input/output module 420 assesses and validates the data (Operation 506).

In an embodiment, data preprocessing module 422 receives the validated dataset intended for inference (Operation 507). Data preprocessing module 422 ensures that the data format used in training is replicated for the new inference data, maintaining consistency and accuracy for the model's predictions.

In an embodiment, inference module 430 processes the new data set intended for inference, using the trained and tuned model (Operation 508). It applies the model to this data, generating raw probabilistic outputs for predictions. Inference module 430 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 440 allows for applications to leverage machine learning engine 400. In an embodiment, machine learning engine API 440 may be built on a RESTful architecture and offer stateless interactions over standard HTTP/HTTPS protocols. Machine learning engine API 440 may feature a variety of endpoints, each tailored to a specific function within machine learning engine 400. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 440 is equipped to support SOAP-based interactions. This extension involves defining a WSDL (Web Services Description Language) document that outlines the API's operations and the structure of request and response messages. In an embodiment, machine learning engine API 440 supports various data formats and communication styles. In an embodiment, machine learning engine API 440 endpoints may handle requests in JSON format or any other suitable format. For example, machine learning engine API 440 may process XML, and it may also be engineered to handle more compact and efficient data formats, such as Protocol Buffers or Avro, for use in bandwidth-limited scenarios.

In an embodiment, machine learning engine API 440 is designed to integrate WebSocket technology for applications necessitating real-time data processing and immediate feedback. This integration enables a continuous, bi-directional communication channel for a dynamic and interactive data exchange between the application and machine learning engine 400.

In an embodiment, the machine learning engine 400 can train an LLM based on deep learning that uses a neural network architecture to process and generate data in sequence. The architecture of an LLM is made up of multiple layers of neural networks that work together to process input text and generate output predictions. One layer may be an encoder, which uses a tokenizer to convert text into numerical values, then creates embeddings of those tokens. Another layer may be an embedding layer, which captures the semantic and syntactic meaning of the input text. Another layer may be a feedforward layer, which applies nonlinear transformations to the input embeddings to help the model learn higher-level abstractions. Another layer may be a recurrent layer, which interprets the words in the input text in sequence to capture dependencies between words. Another layer may be an attention mechanism, which allows the model to focus on specific parts of the input text that are relevant to the task at hand. Another layer may be a decoder, which converts the tokens back into words.

A foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

The textual data used to train an LLM can be structured, as in a database, or unstructured. Vast amounts of unstructured data, including text messages, emails, and documents are available for training LLMs. In accordance with one or more embodiments, input/output module 420, when used for large language models, handles textual data, converting input text into a format that the model can process. This typically involves tokenization, where the text is broken down into manageable pieces, such as words or sub-words, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 422 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 424, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 426, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 428 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 430, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Training LLMs can be difficult since they use a large amount of resources, such as GPUs and power. As such, model optimization is utilized to allow for a “smaller training” version with less data, through a process called fine-tuning. Fine-tuning on specific datasets or tasks improves the LLMs' performance on specialized applications.

Fine-tuning involves training an LLM on a particular task or domain. To do this, one can start with an existing pre-trained model and then train the model further using labeled data specific to the task. This process adjusts the model's weights to improve matching of the data, resulting in an improved version of the LLM tailored to the training data.

In full fine-tuning, the entire pre-trained model, including all its layers and parameters, is usually trained. This process can be computationally expensive and time-consuming, especially for large models. Parameters-efficient fine-tuning is another method of fine-tuning that focuses on training only a subset of the pre-trained model's parameters and layers. This approach involves identifying the most important parameters for the new task and only updating those parameters during training. This approach has reduced computational costs and faster training times compared to full fine-tuning.

Another way to improve the performance of the LLM for a specific task is in-context learning. Unlike fine-tuning, in-context learning does not involve training the model with a dataset or changing the model's parameters. In-context learning also does not require additional computational resources beyond what is necessary for model inference.

One way of achieving in-context learning is to provide the LLM with a prompt or set of instructions. Apart from instructions, the prompt can include a context to guide the LLM to generate a context-specific response. Different techniques can be used to pass data context to a prompt.

One technique is to make prompts configurable with variables. A user can define a prompt template that allows the creation of a template string with placeholders for variables. The prompt template can then be formatted with input values to generate the final prompt string, replacing placeholders with corresponding values. These variable values can be obtained via API calls or data extraction techniques. Once the variable substitution is complete, the resulting prompt becomes context specific. This final prompt is passed to the LLM, enhancing its ability to generate relevant and context-specific responses.

Another technique is few-shot prompting, which is used to guide the LLM to generate a desired response by providing them with examples of input-output pairs. These input-output pairs can be obtained from task specific data. This way, the prompt has examples, with which a user can condition the model to generate outputs based on the context.

Another technique is prompt chaining, which is utilized when a single prompt presents a complex task with multiple instructions. Prompt chaining involves breaking down the task into smaller, more manageable sub-tasks and executing them as a chain of prompts. These sub-task prompts can be executed sequentially when the sub-tasks are interdependent. Alternatively, they can be executed in parallel when the sub-tasks are independent. In this process, the response of one sub-task becomes the prompt to the other sub-task, and this chain continues until the overall task is complete. During intermediate steps, the output of each LLM call can be parsed or manipulated, and the resulting output is then fed into the next step of the chain.

Another technique is retrieval augmented generation (RAG), which is an architecture in which an information retrieval system is added which will augment the prompt with relevant context. To ensure efficiency, retrieved information must be sufficiently detailed yet compact enough to fit within the maximum sequence length allowed for a prompt in an LLM. Duc to this consideration, the majority of RAG approaches use vector similarity as the search technique to retrieve contextual information.

LLMs can interact with other software, databases, APIs, and external data sources to accomplish complex tasks. Agents are programs that use an LLM to reason through a task, create a plan to solve the task and execute the plan using a set of tools. LLM agents use tools and task-planning abilities to interact with outside systems and overcome complex problems. Tools can take a variety of forms, such as API calls, Python functions, or database calls. Agents also have a memory module, which can be thought of as a store of the agent's internal logs as well as interactions with a user.

LLMs can be integrated in a cloud infrastructure to provide generative AI service via APIs to users of the cloud infrastructure. The generative AI service may include foundational models such as a generation model which gives instructions to generate text or extract information from a user's text, a summarization model which summarizes text with user instructed format, length, and tone, and an embedding model which converts text to vector embeddings to use in applications for semantic searches, text classification, or text clustering.

A user of the cloud infrastructure can use the generative AI service to try pretrained models, run their prompts, adjust the parameters, update their prompts, and rerun the models until the results are satisfactory. After this process, the user can copy the code exported from the generative AI service into their applications.

The user can also create a copy of a pretrained model, add their own training dataset, and let the generative AI service fine-tune the model. The generative AI service may use powerful dedicated AI clusters specially sized for fine-tuning. These clusters belong only to the user's tenancy. After the user's model is fine-tuned, the generative AI service can create an endpoint for the custom model and host that model on a dedicated AI cluster designed for hosting.

Besides LLMs, another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

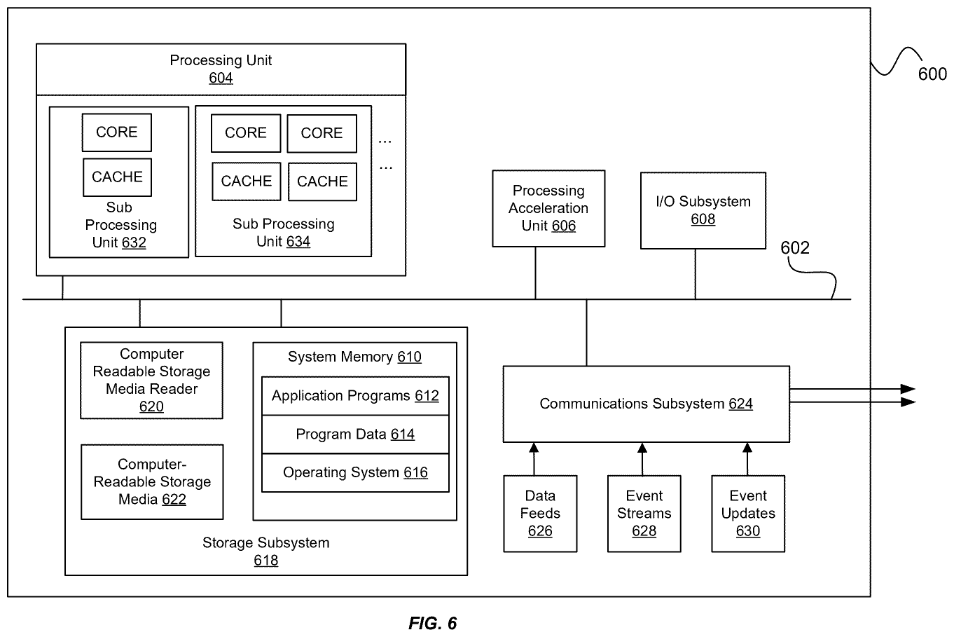

FIG. 6 illustrates an example computer system 600, in which various embodiments may be implemented. The system 600 may be used to implement any of the computer systems described above. As shown in the figure, computer system 600 includes a processing unit 604 that communicates with a number of peripheral subsystems via a bus subsystem 602. These peripheral subsystems may include a processing acceleration unit 606, an I/O subsystem 608, a storage subsystem 618 and a communications subsystem 624. Storage subsystem 618 includes tangible computer-readable storage media 622 and a system memory 610.

Bus subsystem 602 provides a mechanism for letting the various components and subsystems of computer system 600 communicate with each other as intended. Although bus subsystem 602 is shown schematically as a single bus, alternative embodiments of the bus subsystem may utilize multiple buses. Bus subsystem 602 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 604, which can be implemented as one or more integrated circuits (e.g., a conventional microprocessor or microcontroller), controls the operation of computer system 600. One or more processors may be included in processing unit 604. These processors may include single core or multicore processors. In certain embodiments, processing unit 604 may be implemented as one or more independent processing units 632 and/or 634 with single or multicore processors included in each processing unit. In other embodiments, processing unit 604 may also be implemented as a quad-core processing unit formed by integrating two dual-core processors into a single chip.

In various embodiments, processing unit 604 can execute a variety of programs in response to program code and can maintain multiple concurrently executing programs or processes. At any given time, some or all of the program code to be executed can be resident in processor(s) 604 and/or in storage subsystem 618. Through suitable programming, processor(s) 604 can provide various functionalities described above. Computer system 600 may additionally include a processing acceleration unit 606, which can include a digital signal processor (DSP), a special-purpose processor, and/or the like.

I/O subsystem 608 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 600 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 600 may include a storage subsystem 618 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 604 provide the functionality described above. Storage subsystem 618 may also provide a repository for storing data used in accordance with the present disclosure.

As depicted in the example in FIG. 4, storage subsystem 618 can include various components including a system memory 610, computer-readable storage media 622, and a computer readable storage media reader 620. System memory 610 may store program instructions that are loadable and executable by processing unit 604. System memory 610 may also store data that is used during the execution of the instructions and/or data that is generated during the execution of the program instructions. Various different kinds of programs may be loaded into system memory 610 including but not limited to client applications, Web browsers, mid-tier applications, relational database management systems (RDBMS), virtual machines, containers, etc.

System memory 610 may also store an operating system 616. Examples of operating system 616 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 600 executes one or more virtual machines, the virtual machines along with their guest operating systems (GOSs) may be loaded into system memory 610 and executed by one or more processors or cores of processing unit 604.

System memory 610 can come in different configurations depending upon the type of computer system 600. For example, system memory 610 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 610 may include a basic input/output system (BIOS) containing basic routines that help to transfer information between elements within computer system 600, such as during start-up.

Computer-readable storage media 622 may represent remote, local, fixed, and/or removable storage devices plus storage media for temporarily and/or more permanently containing, storing, computer-readable information for use by computer system 600 including instructions executable by processing unit 604 of computer system 600.

Computer-readable storage media 622 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 622 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 622 may include, but is not limited to, Zip® drives, flash memory cards, universal serial bus (USB) flash drives, secure digital (SD) cards, DVD disks, digital video tape, and the like. Computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 600.

Machine-readable instructions executable by one or more processors or cores of processing unit 604 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 624 provides an interface to other computer systems and networks. Communications subsystem 624 serves as an interface for receiving data from and transmitting data to other systems from computer system 600. For example, communications subsystem 624 may enable computer system 600 to connect to one or more devices via the Internet. In some embodiments communications subsystem 624 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 624 can provide wired network connectivity (e.g., Ethernet) in addition to or instead of a wireless interface.

In some embodiments, communications subsystem 624 may also receive input communication in the form of structured and/or unstructured data feeds 626, event streams 628, event updates 630, and the like on behalf of one or more users who may use computer system 600.

By way of example, communications subsystem 624 may be configured to receive data feeds 626 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 624 may also be configured to receive data in the form of continuous data streams, which may include event streams 628 of real-time events and/or event updates 630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 624 may also be configured to output the structured and/or unstructured data feeds 626, event streams 628, event updates 630, and the like to one or more databases that may be in communication with one or more streaming data source computers coupled to computer system 600.

Computer system 600 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 600 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. One or more non-transitory computer-readable media storing instructions that, when executed by one or more processors, cause performance of:
accessing a user input comprising a task description and a set of training data configured for prompt tuning;
generating, by an optimizer large language model (LLM) and based on the task description, a baseline prompt;
generating, by a target LLM and based on the baseline prompt, an output responsive to the user input;
generating, by the optimizer LLM and based on the set of training data and the output, one or more modifications to the baseline prompt; and
generating, by the optimizer LLM and based on the one or more modifications, a final prompt.

2. The media of claim 1, wherein the instructions when executed by the processors, cause further performance of:
accessing a user query associated with a task associated with the task description; and
generating, by the target LLM and based on the final prompt, a response to the user query.

3. The media of claim 1, wherein the instructions when executed by the processors, cause further performance of:
accessing the target LLM via an application programming interface (API).

4. The media of claim 1, wherein the one or more modifications comprise one or more of modifying prompt structure, adjusting wording, providing additional context, or incorporating relevant examples.

5. The media of claim 1, wherein the set of training data comprise one or more input-output pairs, each input-output pair comprising an example input to an LLM and an example output by the LLM.

6. The media of claim 5, wherein the example output exemplifies one or more of a desired output style, a desired output format, or an output requirement.

7. The media of claim 5, wherein generating the output responsive to the user input by the target LLM and based on the baseline prompt and generating the modifications to the baseline prompt by the optimizer LLM and based on the set of training data and the output are iterated for a number of iterations corresponding to a number associated with the input-output pairs.

8. The media of claim 7, wherein, during each iteration, generating the modifications to the baseline prompt by the optimizer LLM is based on one distinct input-output pair of the input-output pairs.

9. The media of claim 5, wherein the set of training data comprise no more than five input-output pairs.

10. The media of claim 1, wherein the instructions when executed by the processors, cause further performance of:
providing, to the optimizer LLM, an instruction to incorporate chain-of-thought reasoning when generating prompts, wherein the baseline prompt and the modifications to the baseline prompt are based on chain-of-thought reasoning.

11. The media of claim 1, wherein the instructions when executed by the processors, cause further performance of:
accessing a plurality of inputs to the target LLM and plurality of outputs generated by the target LLM responsive to the respective inputs; and
identifying, by the optimizer LLM and based on an analysis of the accessed inputs and outputs, one or more edge cases where the target LLM generated incorrect or unexpected outputs.

12. The media of claim 11, wherein the instructions when executed by the processors, cause further performance of:
generating, by the optimizer LLM and based on the edge cases, one or more modifications to the baseline prompt.

13. The media of claim 11, wherein the analysis of the accessed inputs and outputs comprises one or more of anomaly detection, outlier detection, or clustering analysis.

14. The media of claim 1, wherein the optimizer LLM and the target LLM are based on different models.

15. The media of claim 1, wherein the optimizer LLM and the target LLM are based on a same model.

16. A system comprising: one or more processors; and a non-transitory memory coupled to the processors comprising instructions, when executed using the processors, cause the system to execute:
accessing a user input comprising a task description and a set of training data configured for prompt tuning;
generating, by an optimizer large language model (LLM) and based on the task description, a baseline prompt;
generating, by a target LLM and based on the baseline prompt, an output responsive to the user input;
generating, by the optimizer LLM and based on the set of training data and the output, one or more modifications to the baseline prompt; and
generating, by the optimizer LLM and based on the one or more modifications, a final prompt.

17. The system of claim 16, wherein the instructions when executed using the processors, cause the processors to further execute:
accessing a user query associated with a task associated with the task description; and
generating, by the target LLM and based on the final prompt, a response to the user query.

18. The system of claim 16, wherein the instructions when executed using the processors, cause the processors to further execute:
accessing the target LLM via an application programming interface (API).

19. A method comprising, by one or more computing systems:
accessing a user input comprising a task description and a set of training data configured for prompt tuning;
generating, by an optimizer large language model (LLM) and based on the task description, a baseline prompt;
generating, by a target LLM and based on the baseline prompt, an output responsive to the user input;
generating, by the optimizer LLM and based on the set of training data and the output, one or more modifications to the baseline prompt; and
generating, by the optimizer LLM and based on the one or more modifications, a final prompt.

20. The method of claim 19, further comprising:
accessing a user query associated with a task associated with the task description; and
generating, by the target LLM and based on the final prompt, a response to the user query.
